(19) United States
(12) Patent Application Publication
(10) Pub. No.: US 2025/0206294 A1
(43) Pub. Date: Jun. 26, 2025

(54) ACCIDENT PREVENTION SYSTEM

(71) Applicant: ZF Friedrichshafen AG, Friedrichshafen (DE)

(72) Inventor: Mehrdad SALARI, Überlingen (DE)

(21) Appl. No.: 18/850,240

(22) PCT Filed: Feb. 20, 2023
(86) PCT No.: PCT/EP2023/054128

§ 371 Date: Sep. 24, 2024

(30) Foreign Application Priority Data
Mar. 24, 2022 (DE) 102022202906.2

(51) Int. Cl. B60W 30/09; B60W 60/00; G08G 1/16

(52) U.S. Cl. CPC B60W 30/09; B60W 60/0015; G08G 1/166; B60W 2420/403; B60W 2420/408; B60W 2554/4044; B60W 2710/18; B60W 2710/20; B60W 2720/106

(57) ABSTRACT

A device for initiating a driving manoeuvre, comprising: an input interface for receiving environmental sensor data comprising information on a first road user and a second road user in the environment of an autonomous or semi-autonomous host vehicle and comprising information on objects in the environment of the host vehicle; an evaluation unit for determining whether a collision between the first road user and the second road user is imminent, on the basis of the environmental sensor data; a planning unit for planning a driving manoeuvre of the host vehicle on the basis of the environmental sensor data if a collision is imminent, wherein the driving manoeuvre creates an avoidance possibility for the first road user and/or second road user in order to prevent the collision; and, an output unit for outputting the driving manoeuvre to a vehicle control unit of the host vehicle. The present invention also relates to a system and to a method.

### CROSS-REFERENCE TO RELATED APPLICATIONS

This application is a national stage of International Application No. PCT/EP2023/054128, filed Feb. 20, 2023, the disclosure of which is incorporated herein by reference in its entirety, and which claims priority to German Patent Application No. 10 2022 202 906.2, filed Mar. 24, 2022, the disclosure of which is incorporated herein by reference in its entirety.

### TECHNICAL FIELD

The present disclosure relates to a device for introducing a driving maneuver. The present disclosure also relates to a system and a method for initiating a driving maneuver and to a computer program.

### BACKGROUND

Modern vehicles (cars, trucks, motorcycles, etc.) have a variety of sensors (radar, lidar, camera, ultrasound, etc.) that provide information to a vehicle driver or an autonomous control system of the vehicle. Based on this information, a control of individual functions of the vehicle or a partially or fully autonomous operation of the vehicle can be realized. Advanced Driver Assistance Systems (ADAS) are electronic devices in motor vehicles that support a driver in certain driving situations. This focus is often on safety aspects.

The SAE (Society of Automotive Engineers) classification of autonomous driving comprises six levels of advanced driver assistance systems in which vehicles and/or assistance systems are classified based on their degree of autonomy. In stages 0 and 2, the driver performs at least some or all of the driving operations and monitors the vehicle environment. In levels 3 to 5, the driver assistance system already takes over a significant part of driving and monitoring of the vehicle environment. From stage 4 onwards, this is referred to as high automation. Depending on the driving mode, all aspects of the dynamic driving task are taken over by an automated driving system without the expectation that the driver reacts to the request for intervention. Without a human reaction, the vehicle continues to steer automatically.

In this context, Automated Emergency Steering (AES) systems that are trained to perform driving maneuvers to prevent accidents shall be discussed. For example, during an automated lane change, a lane is cleared for driving to avoid an accident.

One approach for determining corresponding driving maneuvers is the so-called cooperative driving planning. In Frese, “Planning of Cooperative Driving Maneuvers for Cognitive Automobiles,” dissertation 2011, an approach to planning the cooperative behavior of cognitive automobiles is disclosed in this context. The starting points are cognitive vehicles with sensors and actuators that perceive their environment, interpret traffic situations, communicate via radio and can perform automatic driving maneuvers. Various algorithms for collision avoidance and cooperative motion planning are presented and investigated.

One challenge in this context is that it may be difficult to integrate non-communication-capable road users into decision-making. In the development of cooperative driving maneuvers in which all participants contribute to accident prevention or risk reduction, communication between the vehicles involved is usually required. In addition to older vehicles, vulnerable road users such as cyclists or pedestrians are usually not able to participate in corresponding vehicle-to-vehicle communication approaches (vehicle-to-vehicle, V2V). Accordingly, input from these road users can often not be taken into account when designing a cooperative driving maneuver.

### SUMMARY

What is needed is to provide an approach for reducing the risk of accidents. The safety of road users is to be improved. For example, safety should be improved if it is assumed that at least some of the road users involved are partially or fully autonomous vehicles.

The present disclosure relates, in a first aspect, to a device for initiating a driving maneuver, having:
an input interface for receiving environment sensor data from one or more sensors, including information about a first road user and a second road user in an environment of an autonomous or partially autonomous vehicle of its own and information about objects in the environment of its own vehicle;
an evaluation unit for determining whether a collision between the first road user and the second road user is imminent based on the environment sensor data;
a scheduling unit for scheduling a driving maneuver of the own vehicle based on the environmental sensor data when a collision is imminent, wherein the driving maneuver provides the first road user and/or the second road user with an evasive possibility for avoiding the collision; and
an output unit for outputting the driving maneuver to a vehicle control unit of the own vehicle.

In a further aspect, the present disclosure relates to a system for initiating a driving maneuver, comprising:
a device as described above;
an environment sensor for detecting objects in the environment of the own vehicle; and
a vehicle control unit for controlling actuators of the vehicle for executing the driving maneuver.

Further aspects of the disclosure relate to a method corresponding to the device and to a computer program with program code for carrying out the steps of the method when the program code is executed on a computer. In addition, one aspect of the disclosure relates to a storage medium on which a computer program is stored which, when executed on a computer, effects an execution of the method described herein.

Exemplary arrangements of the disclosure are described in the dependent claims. The features mentioned above and those yet to be explained below can be used not only in the combination indicated in each case, but also in other combinations or on their own, without departing from the scope of the present disclosure. For example, the system, the method and the computer program product can be implemented in accordance with the exemplary arrangements defined for the device in the dependent claims.

According to the disclosure, environmental sensor data are received by an environmental sensor. For example, at least two other road users are detected or perceived in the environment of their own vehicle. Based on the environmental sensor data, it is determined whether a collision is imminent between these two other road users. If this is the case, a driving maneuver of the driver's own vehicle is planned and initiated in order to give the other two road users the opportunity to avoid the collision. For example, a driver's own driving maneuver provides at least one of the two other road users with an evasive maneuver.

Compared to previous approaches in which communication between all road users involved is used, such a communication is not necessary in the approach according to the disclosure. For example, it is sufficient if two further road users are detected via the environmental sensor system. Communication is not required. A corresponding reaction can then take place by a separate driving maneuver. This reaction of the driver's own vehicle reduces the probability of a collision between the other two road users.

Compared to previous approaches in which a collision between one's own vehicle and another road user is to be prevented by a driving maneuver, the aim of the disclosure is to avoid or prevent a collision between two other road users. It is therefore assumed that there is no risk of collision for one's own vehicle. In this respect, the safety of other road users is improved by a separate driving maneuver.

Since no communication is required, it is possible that, in addition to avoiding accidents between vehicles, accidents between vehicles and other road users, such as cyclists or pedestrians, can also be avoided. For example, an onboard vehicle can be given the opportunity to avoid a pedestrian entering the road by its own driving maneuver. In this respect, the safety of road users is increased.

For example, if it is assumed that at least one autonomous or partially autonomous vehicle is involved, the inventive approach results in improved safety of the autonomous or partially autonomous vehicle as well as of the other road users. This is due to the fact that the autonomous or semi-autonomous vehicle can under certain circumstances react to the reaction of its own vehicle by an adapted rapid reaction of its own and can thus prevent an accident or a collision.

In an exemplary arrangement, the evaluation unit is designed to determine a probability of a collision. The evaluation unit may be designed to compare the probability with a predefined threshold value. For example, it is advantageous if a probability calculation for a collision is carried out by a corresponding Al algorithm. It is thus determined whether there is a high probability of a collision between the two other road users. A comparison of this probability of truth with a predefined threshold value results in simple decision-making and efficient calculability. The safety of the other two road users is increased.

In one exemplary arrangement, the evaluation unit is designed to determine whether a line of sight exists between the first road user and the second road user, based on the environment sensor data.

A criterion for the occurrence of accidents or collisions is mutual occlusion. If at least one of the other two road users cannot see or perceive the other, this can lead to a collision being imminent. Under certain circumstances, it is possible for one's own vehicle to have a line of sight to both further road users, whereas there is no line of sight between these two further road users. For example, a pedestrian protruding behind a parked vehicle may be seen from his own vehicle, but not from an oncoming second vehicle. In these situations, it helps if one's own vehicle performs a driving maneuver, giving the second vehicle or the second road user the opportunity to employ evasive action. In this context, a line of sight is in also to be understood to be detectable by environmental sensors. The safety of the road users involved is further improved.

In one exemplary arrangement, the evaluation unit is designed to determine an increased probability of a collision when there is no line of sight. For example, dangerous situations can occur if there is no line of sight between the two other road users. The probability of a collision determined in the actual vehicle advantageously increases in these cases. This improves the safety of other road users.

In one exemplary arrangement, the evaluation unit is designed to determine whether the inherent vehicle blocks the line of sight between the first road user and the second road user. The planning unit is designed to plan an evasive maneuver by which the line of sight between the first road user and the second road user is restored. Assuming that a line of sight is blocked by one's own vehicle, the probability of a collision between the two other road users can be reduced by releasing this line of sight. If such a situation is recognized, an evasive process is planned by the planning unit in order to release this line of sight. The two other road users can then react in a corresponding manner in order to avoid a collision.

In one exemplary arrangement, the planning unit is designed for planning a braking operation and/or avoidance operation, by which a first vehicle passing over its own vehicle is given an opportunity for shearing in front of its own vehicle to avoid a collision with an oncoming second vehicle. The first and second vehicles correspond to the first and second road users. During an overtaking process in which one's own vehicle is overtaken, one reacts accordingly in order to avoid collision between the first vehicle and the second vehicle. A separate driving maneuver is therefore used to ensure the safety of the two other road users increased. For this purpose, a braking or even an evasive maneuver can be carried out.

In one exemplary arrangement, the planning unit is designed to plan an evasive maneuver, by which an evasion of the driver's own vehicle to a side strip is effected. If there is a hard shoulder, this can exceptionally be used by the driver's own vehicle to improve the safety of the two other road users. When planning the driving machine requirement, the driver's own safety of the vehicle is also advantageously considered and taken into consideration. If a driving maneuver can be performed without endangering the driver's own vehicle, it is performed.

In one exemplary arrangement, the evaluation unit is designed to determine whether a collision is imminent, based on an artificial intelligence approach, for example based on a pretrained artificial neural network. By using an AI approach, high reliability with efficient predictability is achieved. For example, a pre-trained artificial neural network is suitable for this purpose in order to make a decision as to whether a collision between the two other road users is imminent. This pre-trained artificial neural network can also be based, for example, on corresponding accident studies on driving situations that can lead to accidents. There is a high reliability in detecting whether a collision is imminent and thus an increased potential for avoiding collisions between the two other road users.

In one exemplary arrangement, the evaluation unit is designed to neglect data from direct communication with the first road user and/or the second road user. Direct communication, such as that required for cooperative approaches, is not necessary. In this respect, the approach according to the disclosure can also be applied to vehicles which do not have communication possibilities. Road traffic safety is increased, especially in the transition period from conventional vehicles to partially and/or fully autonomous vehicles with V2V communication options.

In one exemplary arrangement, the input interface is designed for receiving the environmental sensor data from a radar, camera and/or lidar sensor. For example, the device can be connected to corresponding sensors within a vehicle via the input interface. This results in increased reliability with little installation effort.

In one exemplary arrangement, the output unit is designed to control a steering and an acceleration and braking system of the vehicle. A corresponding acceleration and braking system is usually connected to a corresponding vehicle control unit. Such a system can initiate an acceleration and/or braking process as well as an evasive process.

Herein, a road user is understood to be a vehicle. It goes without saying, however, that the term may also include other road users, such as pedestrians or cyclists. A driving maneuver is understood to be, for example, a maneuver of a vehicle for which the vehicle is steered, accelerated and/or braked and to this extent deviates from a previous current travel plan. Information on road users can include, in particular, their direction of movement, their speed, their size, their type, etc. To determine this information on the basis of the environmental sensors, existing algorithms can be used. For example, algorithms of image evaluation or sensor data evaluation can be used. A collision is understood to mean a collision. However, it is also possible to define a zone around a road user that is already considered a collision zone. In this respect, a collision can also correspond to an entry into a protected area of a traffic subscriber. An environment of a vehicle comprises an area which can be detected from this vehicle by environmental sensors.

### BRIEF DESCRIPTION OF THE DRAWINGS

The disclosure is described and explained in more detail below with reference to a few selected exemplary arrangements in conjunction with the accompanying drawings. It shows:

FIG. 1 is a schematic representation of a system according to the disclosure for initiating a driving maneuver;

FIG. 2 is a schematic representation of a device according to the disclosure;

FIGS. 3a and 3b schematically illustrate an example of an initiated driving maneuver; and

FIG. 4 schematically illustrates a method according to the disclosure.

### DETAILED DESCRIPTION

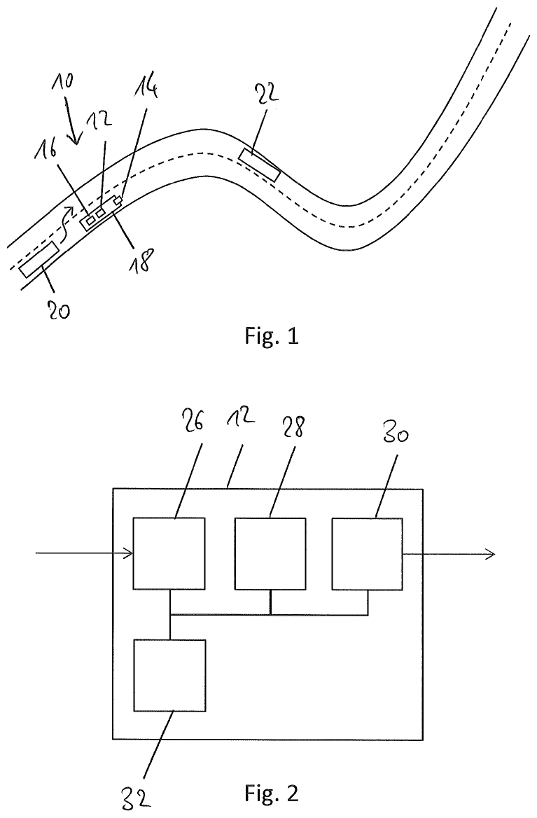

In FIG. 1 system 10 according to the disclosure for initiating a driving maneuver is shown schematically. The system 10 comprises a device 12, an environment sensor 14 and a vehicle control unit 16. The illustration is to be understood as a bird's-eye perspective top view of a driving situation on a road. In the exemplary arrangement shown, the device 12, the environmental sensor 14 and the vehicle control unit 16 are arranged within a separate vehicle 18. In other exemplary arrangements, it is also conceivable, for example, for the device 12 and/or the environmental sensor 14 to be arranged outside the vehicle 18, for example in a mobile telephone or a similar device.

In the exemplary arrangement shown, a first road user starts 20 a passing maneuver in order to overtake vehicle 18. An oncoming second traffic participant 22 is located outside a line of sight to the first traffic participant 20. According to the disclosure, the system 10 detects whether a collision between the first road user 20 and the second road user is 22 imminent. If this is the case, a driving maneuver of the driver's own vehicle is 18 initiated in order to 22 prevent collision between the first road user 20 and the second road user or to 20. 22 provide the two other road users with an alternative.

In this respect, an approach is provided in which a collision between two further driving maneuvers of the driver's own vehicle 18 can be prevented for road users 20, 22, i.e. their safety can be increased. In this case, a driving maneuver is understood to be, for example, an evasive maneuver by which the driver's own vehicle 18 is steered onto a side strip, or else a braking maneuver in order to enable the first road user 20 to cut in in front of the driver's own vehicle 18 before a collision with the oncoming second road user 20 occurs. In the approach according to the disclosure, no communication is required between the driver's own vehicle 18 and the two other road users 20, 22. For example, no cooperative planning is required. The approach also works in cases where at least one of the participants has no V2V communication capability. This results in a simplified approach without requiring communication between vehicles.

The initiation of the driving maneuver takes place by the vehicle control unit 16, which is designed to influence the travel planning of its own vehicle. For example, the vehicle control unit 16 can be designed to steer, brake and/or accelerate one's own vehicle 18. For example, corresponding actuators of the driver's own vehicle 18 are controlled.

In FIG. 2 a device according to the disclosure 12 for initiating a driving maneuver is shown schematically. The device 12 comprises an input interface 26, an evaluation unit 28, a planning unit 30 as well as an output unit 32. The units and interfaces can be partially or completely converted into software and/or hardware. For example, the units can be designed as a processor, processor modules or also as software for a processor. The device 12 can be designed in the form of a control unit or a central computer of an autonomous or partially autonomous vehicle or as software for such a control unit or a central computer of an autonomous or partially autonomous vehicle.

The input interface 26 is designed to receive environmental sensor data. For this purpose, the input interface 26 is connected, for example via a vehicle bus system, to environmental sensors mounted on the vehicle.

A connection to a radar, LIDAR and/or camera sensor of the vehicle is may also be beneficial.

The evaluation unit 28 determines whether a collision between a first road user and a second road user is imminent. For this purpose, the environmental sensor data is evaluated. First, it is determined, using the environmental sensor data in connection with corresponding algorithms whether two road users are present in the environment of one's own vehicle. It is then determined for these participants whether a collision is imminent. For example, it is possible to create a forecast for the movements of the two other road users based on a current movement profile. It can then be determined whether a collision appears likely. For example, it is advantageous if a probability value is determined in the evaluation unit. Such a probability can be indicated, for example, in the form of a percentage value. If this probability value is then above a threshold value which, for example, may have been predefined and determined in a study, it can be determined that a collision is imminent or highly probable. The evaluation unit 28 can implement an artificial neural network in order to predict a collision probability based on sensor data. However, it is also possible for a corresponding evaluation to be carried out based on deterministic Al algorithms.

Due to the planning unit, a driving maneuver of the driver's own vehicle may be planned if it was previously determined that a collision between the two other traffic participants is imminent. For this purpose, the environment sensor data may also be used. For example, it is evaluated whether it is possible to perform a driving maneuver that does not endanger one's own vehicle and reduces the collision probability between the two other traffic participants. For this purpose, it is also possible to resort to approaches of artificial intelligence, for example, to an artificial neural network. It is also possible to evaluate probabilities and to select an approach for a driving maneuver in which the probability of a collision and also a danger to one's own vehicle is minimized. The planning unit can also be in communication with the evaluation unit 28 via a vehicle bus system, for example.

Via the output unit 32, the driving maneuver is output to a vehicle control unit of the own vehicle. The vehicle control unit is connected to corresponding actuators of the vehicle. For example, the vehicle control unit can be connected to a braking system, a steering system and/or to an acceleration system. A driving maneuver can be performed by actuating these systems. For example, it is possible to bypass a driver's decision. In this respect, according to the disclosure, an automatic emergency control system is provided, by which a decision of a human driver can also be put into perspective. The output characteristic 32 can also be connected, for example, via a vehicle bus system to corresponding other systems or to corresponding other units.

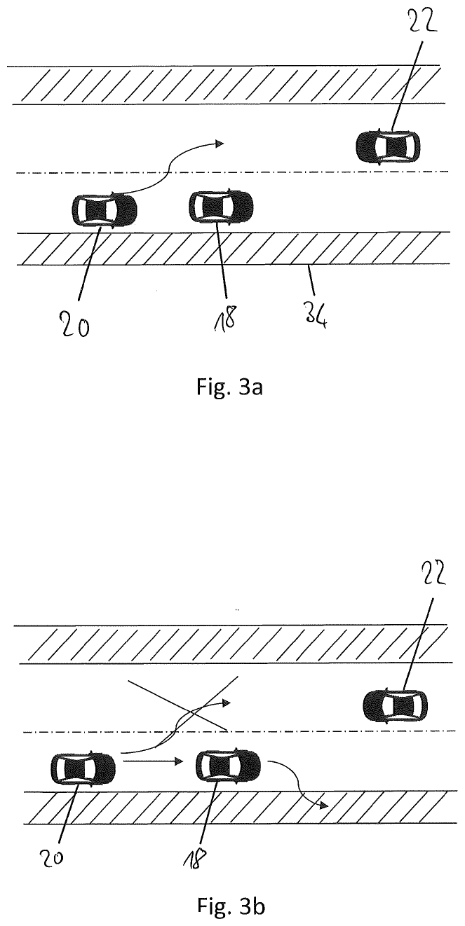

FIGS. 3a and 3b show, by way of example, an approach according to the disclosure for initiating a driving maneuver. A first road user 20 is about to initiate a passing maneuver. The driver's own vehicle 18 is to be overtaken. An oncoming second road user 22 is overlooked, for example. A driving maneuver of the driver's own vehicle is 18 proposed by the system according to the disclosure or the device according to the disclosure. As shown in FIG. 3b and illustrated by the arrows, it is possible in the present case to plan, for example, an evasive process by which the driver's own vehicle evades on a side strip 34. This driving maneuver of the driver's own vehicle 18 makes it possible for the first road user 20 to stop the overtaking process or not to carry it out and thus avoid a collision with the second road user 22.

In other words, it is therefore sufficient if only one's own vehicle 18 is equipped with corresponding sensors and with a corresponding control unit. Using the corresponding sensors, the driver's own vehicle 18 thus that an oncoming vehicle is the first road user 20 to approach. In addition, the driver's own vehicle 18 sees that a following vehicle, as the second commuter 22, is about to perform an overtaking maneuver. If now if it is determined that, based on the environmental sensor data, a successful conclusion of the overtaking maneuver is not possible or unlikely and an accident cannot be avoided or can only be avoided with difficulty, the system according to the disclosure or the device according to the disclosure decides that a steering to the right in order to use the side strip (FIG. 3b) which still makes collision avoidable.

In the exemplary arrangement shown, there may be advantages over a braking maneuver. On the one hand, it is possible for a line of sight to be re-established between the first traffic participant 20 and the second traffic participant 22 only as a result of the avoidance of one's own vehicle 18, and for a reaction to occur. On the other hand, it is possible that the approaching other road users 22 will remain on their track. The first road user 20 overtaking can still use the right lane to overtake the driver's own vehicle 18. It goes without saying that it can advantageously be provided that the system proposed according to the disclosure combines an evasive action with a braking action.

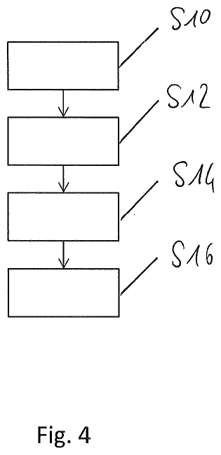

In FIG. 4 schematically illustrates a method according to the disclosure for initiating a driving maneuver. The method comprises steps of receiving data S10 from environmental sensors, determining S12 whether a collision is imminent, plotting S14 from a driving maneuver and outputting S16 the driving maneuver. The method can be implemented in the form of software which is executed on a processor or a central computer of an autonomous vehicle or in a corresponding vehicle control unit. It goes without saying that the procedure can also be implemented as a smartphone app. The supply of the corresponding environmental sensor data or the output of the driving machine request can then be realized via a wired or wireless connection of the smartphone to the corresponding units of the vehicle.

The disclosure has been comprehensively described and explained with reference to the drawings and the description. The description and explanation are to be understood as examples and not restrictive. The invention is not limited to the disclosed exemplary arrangements. Other arrangements or variations result for the person skilled in the art when using the present disclosure as well as in a precise analysis of the drawings, the disclosure and the subsequent patent claims.

In the patent claims, the words “comprise” and “with” do not exclude the presence of further elements or steps. The undefined article “one” or “one” does not exclude the presence of a plurality. A single element or a single unit can carry out the functions of several of the units mentioned in the patent claims. An element, a unit, an interface, a device and a system can be partially or completely converted into hardware and/or software. The mere mention of some measures in several different dependent patent claims is not to be understood as meaning that a combination of these measures cannot also be used advantageously. A computer program can be stored/distributed on a non-volatile data carrier, for example on an optical memory or on a semiconductor drive (SSD). A computer program can be distributed together with hardware and/or as part of a hardware, for example by means of the Internet or by means of wired or wireless communication systems. Reference marks in the patent claims are not to be understood as limiting.

1. A device for initiating a driving maneuver, comprising:
an input interface for receiving environmental sensor data having information about a first road user and a second road user in an environment of an autonomous or partially autonomous vehicle and information about objects in the environment of the autonomous or partially autonomous vehicle;
an evaluation unit for determining whether a collision between the first road user and the second road user is imminent based on the environmental sensor data;
a scheduling unit for scheduling a driving maneuver of the autonomous or partially autonomous vehicle based on the environmental sensor data when a collision is imminent, wherein the driving maneuver provides an evasive possibility for the first road user and/or the second road user to avoid the collision; and
an output unit for outputting the driving maneuver to a vehicle control unit of the autonomous or partially autonomous vehicle.

2. The device of claim 1, wherein the evaluation unit is adapted to determine a probability of collision; and to compare the probability with a predefined threshold value.

3. The device of claim 1, wherein the evaluation unit is configured to determine whether there is a visual link based on the environmental sensor data between the first road user and the second road user.

4. The device according to claim 2, wherein the evaluation is configured for determining an increased probability of collision when there is no line of sight.

5. The device of claim 3, wherein
the evaluation unit in the autonomous or partially autonomous vehicle for determining whether a line of sight between the first road user and the second road user is blocked; and the scheduling unit is adapted to plan an avoidance operation by the autonomous or partially autonomous vehicle which the line of sight between the first road user and the second road user is restored.

6. The device according to claim 1, wherein the scheduling unit is designed to plan a braking action and/or an evasive action, by which a first vehicle passing the autonomous or partially autonomous vehicle is given a possibility of steering in front of the autonomous or partially autonomous vehicle to avoid a collision with an oncoming second vehicle.

7. The device according to claim 1, wherein the scheduling unit is designed to plan an evasive process by which an evasion of the autonomous or partially autonomous vehicle to a side strip of the roadway is effected.

8. The device according to claim 1, wherein the evaluation unit is designed to determine whether a collision is imminent, based on a pretrained artificial neural network.

9. The device according to claim 1, wherein the evaluation unit is designed to ignore data from direct communication with the first road user and/or the second road user.

10. The device according to claim 1, wherein the input interface is designed to receive the environmental sensor data from a camera, radar and/or lidar sensor.

11. The device according to claim 1, wherein the output unit is designed to control a steering and an acceleration and braking system of the autonomous or partially autonomous vehicle.

12. A system for initiating a driving maneuver, comprising:
a device according to claim 1;
an environment sensor for detecting objects in the environment of the autonomous or partially autonomous vehicle; and
a vehicle control unit for controlling actuators of the autonomous or partially autonomous vehicle for executing the driving maneuver.

13. A method of initiating a driving maneuver comprising the steps of:
receiving environmental sensor data form environmental sensors, including information about a first road user and a second road user in an environment of an autonomous or partially autonomous vehicle and information about objects in the environment of the autonomous or partially autonomous vehicle;
determining whether a collision between the first road user and the second road user is imminent based on the environmental sensor data;
scheduling a driving maneuver of the autonomous or partially autonomous vehicle based on the environmental sensor data when a collision is imminent, wherein the driving maneuver provides an evasive possibility for the first road user and/or the second road user to avoid the collision; and
outputting the driving maneuver to a vehicle control unit of the autonomous or partially autonomous vehicle.

14. (canceled)

15. The device according to claim 3, wherein the evaluation is configured for determining an increased probability of collision when there is no line of sight.
